(19) United States
(12) Patent Application Publication
(10) Pub. No.: US 2008/0007595 A1
(43) Pub. Date: Jan. 10, 2008

(54) Methods of Etching Polymeric Materials Suitable for Making Micro-Fluid Ejection Heads and Micro-Fluid Ejection Heads Relating Thereto

(76) Inventors: John William Krawczyk, Richmond, KY (US); Andrew Lee McNees, Lexington, KY (US); Girish Shivaji Patil, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/456,231

(22) Filed: Jul. 10, 2006

(51) Int. Cl. B41J 2/16

(52) U.S. Cl. 347/47

(57) ABSTRACT

A micro-fluid ejection head structure, methods for making micro-fluid ejection head structures, and methods for etching polymeric nozzle plates. One such micro-fluid ejection head structuring includes a substrate having a plurality of fluid ejection actuators. A thick film layer is attached adjacent the substrate. The thick film layer has a fluid chamber and a fluid flow channel capable of providing fluid to the fluid chamber. A polymeric nozzle plate is attached adjacent the thick film layer. The polymeric nozzle plate includes a nozzle capable of being in fluid communication with one or more of the fluid flow chambers. The nozzle is a plasma etched nozzle defined by a photoresist mask layer.

### TECHNICAL FIELD:

The disclosure relates to improved methods of etching polymeric materials suitable for making micro-fluid ejection heads and to improved micro-fluid ejection heads containing the etched polymeric materials.

### BACKGROUND AND SUMMARY:

Micro-fluid ejection devices, such as ink jet printers continue to evolve as the technology for ink jet printing continues to improve to provide higher speed, higher quality printers. However, the improvement in speed and quality does not come without a price. The micro-fluid ejection heads are more costly to manufacture because of tighter alignment tolerances.

For example, micro-fluid ejection heads were made with nozzle plates containing flow features. The nozzle plates were then aligned, and adhesively attached to a substrate. However, minor imperfections in the substrate or nozzle plate components of the ejection head or improper alignment of the parts may have a significant impact on the performance of the ejection heads. For the purposes of this disclosure, the term “substrate” is intended to include, amongst other substrates, silicon substrates and/or ceramic substrates suitable for use in providing micro-fluid ejection heads.

One advance in providing improved micro-fluid ejection heads is the use of a photoresist layer applied to a device surface of the substrate as a thick film layer. The thick film layer is imaged to provide flow features for the micro-fluid ejection heads. Use of the imaged thick film layer enables more accurate alignment between the flow features and ejection actuators on the device surface of the substrate.

While the use of an imaged photoresist layer improves alignment of the flow features to the ejection actuators, there may still exist alignment problems associated with the nozzle plate. Misalignment between the ejection actuators and corresponding nozzles (sometimes referred to as nozzle holes) in a nozzle plate attached to the thick film layer has a disadvantageous effect on the accuracy of fluid droplets ejected from the nozzles. Actuator and nozzle alignment also has an effect on the mass and velocity of the fluid droplets ejected through the nozzles.

Despite advances made in the production of micro-fluid ejection head structures, there continues to be for example, a need for improved materials and methods that provide enhanced tolerance control without increasing the complexity or number of process steps used to provide the structures.

With regard to the foregoing and other objects, an exemplary embodiment of the disclosure provides micro-fluid ejection head structures, methods for making micro-fluid ejection head structures, and methods for etching polymeric nozzle plates. One such micro-fluid ejection head structure includes a substrate having a plurality of fluid ejection actuators. A thick film layer is attached adjacent the substrate. The thick film layer includes a fluid chamber and a fluid Sow channel capable of providing fluid to the fluid chamber. A polymeric nozzle plate is attached adjacent the thick film layer. The polymeric nozzle plate includes a nozzle capable of being in fluid communication with one or more of the fluid flow chamber. The nozzle is a plasma etched nozzle defined by a photoresist mask layer.

In another embodiment, there is provided a method for etching a polymeric layer adjacent a thick film layer that is adjacent a substrate to provide a polymeric nozzle plate. The method includes attaching a photoimageable masking layer adjacent the polymeric layer. A selected first portion of the masking layer is exposed to actinic radiation while a selected second portion of the masking layer is masked so that the second portion is not exposed to actinic radiation. The photoimageable masking layer is treated with a silylation agent under conditions sufficient to provide an etch resistant masking layer in the selected first portions of the masking layer. The photoimageable masking layer is patterned and etched, and the polymeric layer is etched using a reactive ion etching plasma to provide a plurality of nozzles in the polymeric layer.

In yet another embodiment, there is provided a method for making a micro-fluid ejection head structure. According to the method, a polyimide layer is applied adjacent a thick film layer that is adjacent a substrate. The substrate has a plurality of fluid ejection actuators associated therewith and the thick film layer defines a fluid flow channel and a fluid chamber in flow communication with the fluid flow channel. A photoimageable masking layer is attached adjacent the polyimide layer. A selected first portion of the masking layer is exposed to actinic radiation while selected second portions of the masking layer are masked so that the second portions are not exposed to actinic radiation. The photoimageable masking layer is treated with a silvlation agent under conditions sufficient to provide an etch resistant masking layer in the selected second portions of the masking layer. The photoimageable masking layer is patterned and etched, and the polyimide layer is etched using an oxygen reactive ion etching plasma to provide a plurality of nozzles in the polyimide layer. The photoimageable masking layer is removed from the etched polyimide layer.

A potential advantage of the compositions and/or methods according to exemplary embodiments of the disclosure is that process steps for etching polymeric materials may be simplified while providing more accurate etching of the polymeric materials. Another potential advantage of the exemplary embodiments is that robust polymeric materials may be used and applied to a thick film layer on a substrate without the need to align nozzles in the polymeric layer with flow features in the thick film layer because the nozzles are formed in the polymeric material after the polmeric material and thick film layer are joined to one another.

For purposes of the disclosure, “difunctional epoxy” means epoxy compounds and materials having only two epoxy functional groups in the molecule. “Multifunctional epoxy” means epoxy compounds and materials having more than two epoxy functional groups in the molecule.

### BRIEF DESCRIPTION OF THE DRAWINGS

Further advantages of the exemplary embodiments will become apparent by reference to the detailed description when considered in conjunction with the figures, which are not to scale, wherein like reference members indicate like elements through the several views, and wherein:

FIG. 1 is a cross-sectional view, not to scale, of a portion of a prior art micro-fluid ejection head;

FIGS. 2-3 are schematic illustrations in cross-section, not to scale, of a prior art process for laser ablating a nozzle plate;

FIG. 4 is a plan view, not to scale, of a portion of a prior art micro-fluid ejection head showing a location of flow features therein;

FIG. 5 is a cross-sectional view, not to scale, of a portion of another prior art micro-fluid ejection head;

FIGS. 6-7 are schematic illustrations in cross-section, not to scale, of another prior art process for laser ablating a nozzle plate;

FIGS. 18 are schematic illustrations in cross-section, not to scale, of a process for making a micro-fluid ejection head according to a disclosed embodiment as provided herein;

FIGS. 19-20 are schematic illustrations in cross-section, not to scale, of a portion of an alternative process for making a micro-fluid ejection head according to a disclosed embodiment as provided herein;

FIG. 21 is a perspective view, not to scale, of a fluid cartridge containing a micro-fluid ejection head; and

FIG. 22 is a perspective view, not to scale, of a micro-fluid ejection device.

### DETAILED DESCRIPTION OF EXEMPLARY EMBODIMENTS.

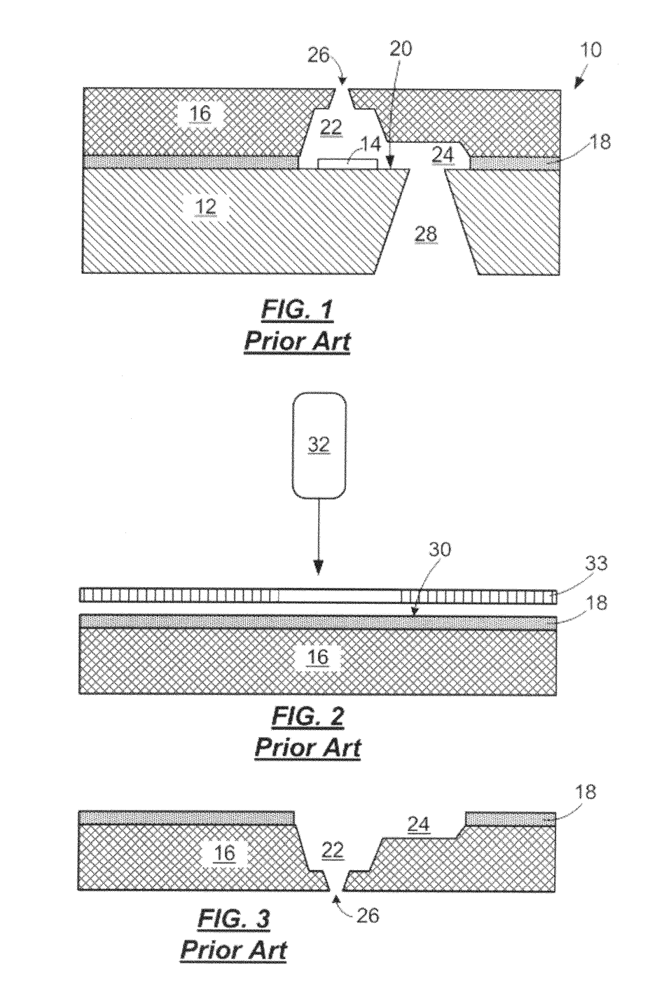

With reference to FIG. 1, there is shown, in partial cross-sectional view, a portion of a prior art micro-fluid ejection head 10. The micro-fluid ejection head 10 includes a support substrate 12 having various insulative, conductive, resistive, and passivating layers providing a fluid ejector actuator 14.

In the prior art micro-fluid ejection head 10, a nozzle plate 16 is attached as by an adhesive 18 to a device surface 20 of the substrate 12. In such a micro-fluid ejection head 10, the nozzle plate 16 may be made out of a laser ablated material such as polyimide. The polyimide material is laser ablated to provide a fluid chamber 22 in fluid flow communication with a fluid flow channel 24. Upon activation of the ejector actuator 14, fluid is expelled through a nozzle 26 that is also laser ablated in the polyimide material of the nozzle plate 16. The fluid chamber 22 and fluid flow channel 24 in this embodiment are collectively referred to as “flow features.” A fluid feed slot 28 is formed in the substrate 12, for example, by wet etching, dry etching, laser ablation, grit blasting, and the like, to provide fluid from a fluid reservoir that is in fluid flow communication with the ejection head 10. Fluid provided from the reservoir flows via the fluid flow channel 24 to the fluid chamber 22.

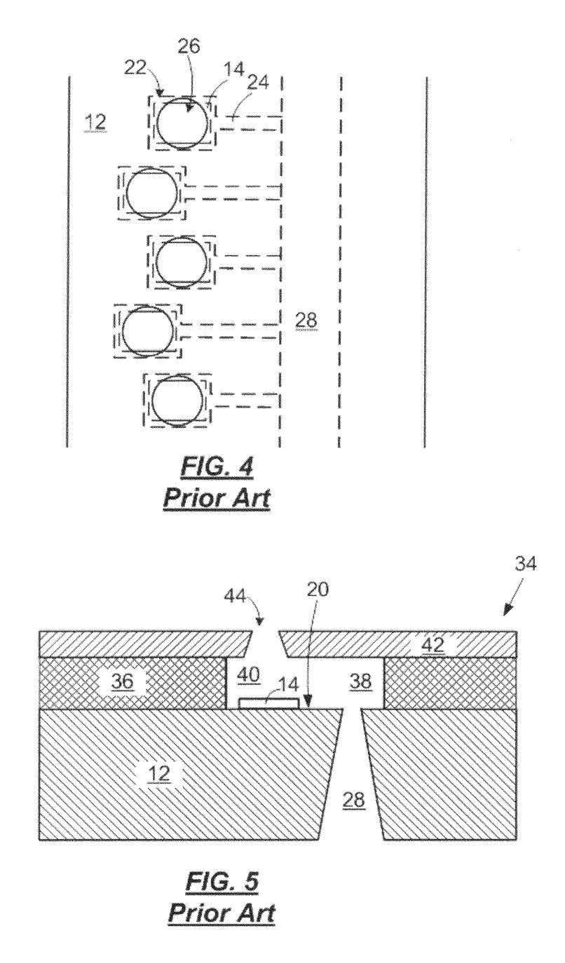

In order to provide the laser ablated nozzle plate 16, the polyimide material is laser ablated from a flow feature side 30 thereof, as shown in FIG. 2, before the nozzle plate 16 is attached to the substrate 12. In FIG. 2, the polyimide nozzle plate 16 and adhesive 18 is laser ablated from the flow feature side 30 thereof using a laser source 32 and a mask 33. The laser ablated nozzle plate 16 and adhesive 18 are illustrated in FIG. 3. The ablated nozzle plate 16 is then aligned with the substrate 12 and attached to the substrate 12 to provide the ejection head 10 illustrated in FIG. 1.

It will be appreciated that the nozzle plate 16 contains a plurality of flow features (22 and 24) laser ablated therein and corresponding to a plurality of ejector actuators 14 as illustrated in plan view in FIG. 4. Accordingly, the foregoing process may lead to misalignment between the flow features (22 and 24) in the nozzle plate 16 and the fluid ejector actuator 14. Such misalignment may be detrimental to the functioning of the micro-fluid ejection head 10.

Another prior art micro-fluid ejection head 34 is illustrated in FIG. 5. In this prior art micro-fluid ejection head 34, a thick film layer 36 provides the flow features, i.e., in this embodiment, a fluid flow channel 38 and a fluid chamber 40 for providing fluid to the fluid ejector actuator 14. In such an ejection bead 34, the thick film layer 36 is a photoresist material that is spin coated onto the device surface 20 of the substrate 12. The photoresist material is then imaged and developed using conventional photoimaging techniques to provide the flow features. A separate nozzle plate 42 having only nozzles, such as nozzle 44, is then attached to the thick film layer 36 such as by thermal compression bonding or by use of an adhesive. As in FIG. 1, the nozzle plate 42 may be made of a laser ablated polyimide material.

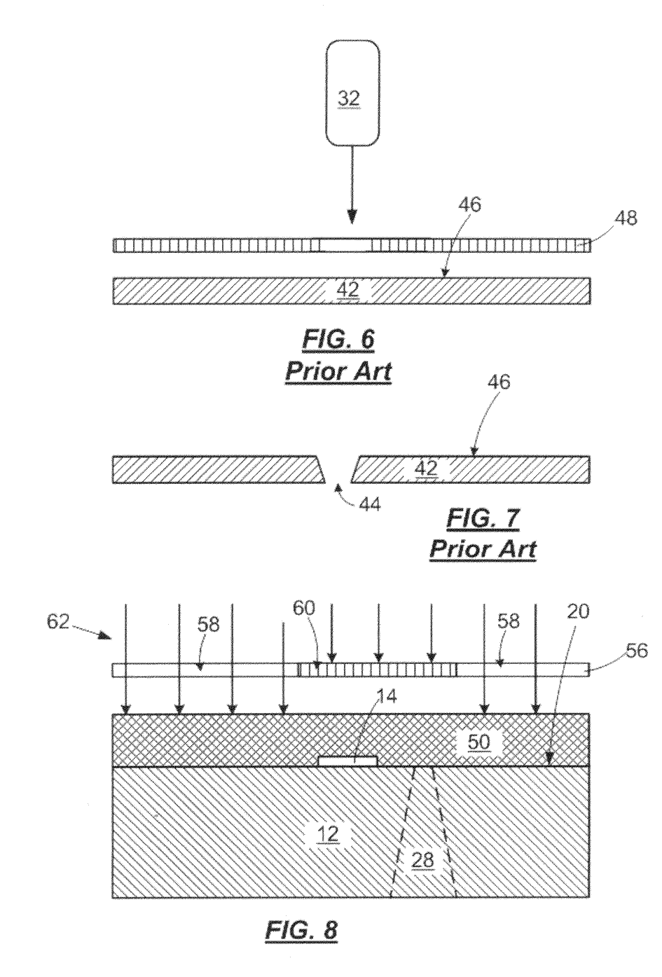

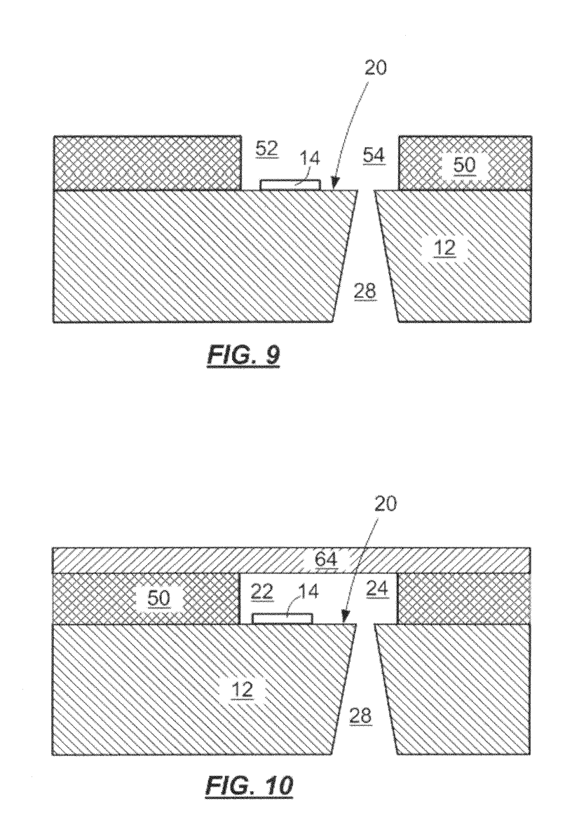

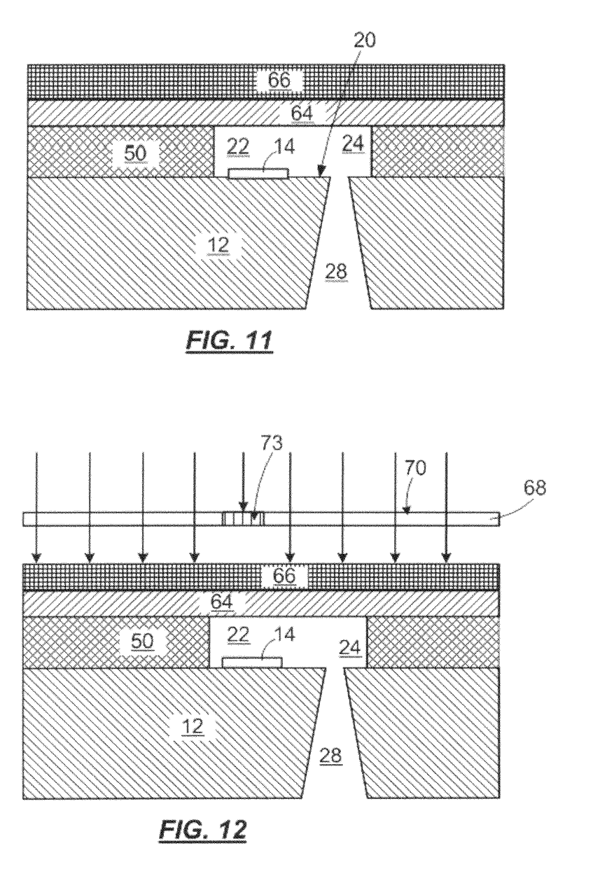

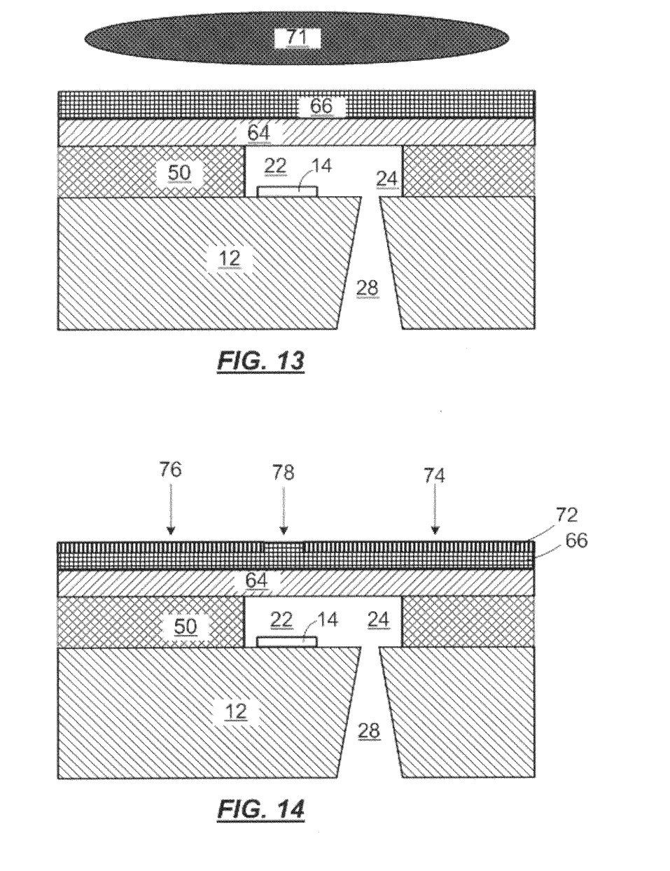

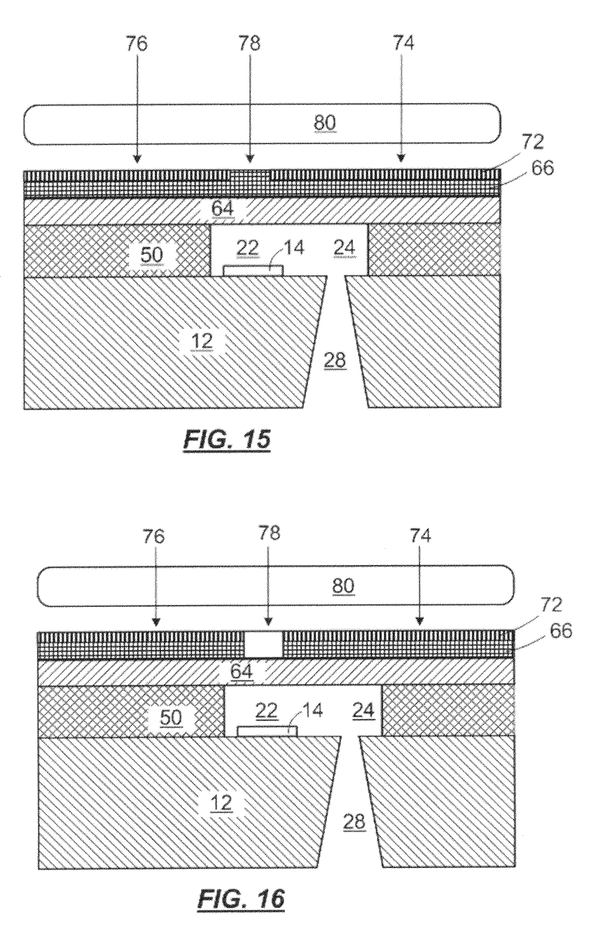

A process for making the nozzles 44 in nozzle plate 42 is illustrated in FIGS. 6 and 7. As before, a laser ablation process is used to form the nozzles 44 from a flow feature side 46 of the nozzle plate 42. A mask 48 is disposed between the laser source 32 and the nozzle plate 42 during the ablation process. After forming the nozzles 44, the nozzle plate 42 is attached to the substrate 12. Since the flow features (38 and 40) and nozzles 44 are formed in separate structures that are then combined, misalignment between the nozzles 44 and flow features (38 and 40) may also occur with this method of producing ejection heads 34.

In order to, for example, improve alignment between nozzles, flow features and/or fluid ejection actuators in a micro-fluid ejection head, an improved micro-fluid ejection head manufacturing process may be used. In such a process, described in more detail below, nozzles in a nozzle plate may be formed after attaching the nozzle plate to a thick film layer using a unique etching process.

Processes for making a micro-fluid ejection head according to the disclosure will now be described with reference to FIGS. 8-20. As a first step in the processes for making a micro-fluid ejection head, a substrate 12 having a plurality of ejection actuator devices 14 is provided.

Next a photoresist material is applied adjacent (e.g., to) the device surface 20 of the substrate 12 to provide a thick film layer 50. In order to apply the photoresist to the device surface 20 of the substrate 12, a substrate wafer may be centered on an appropriate sized chuck of, for example, either a resist spinner or conventional wafer resist deposition track. The photoresist material may be dispensed by hand or mechanically into the center of the wafer, for example. The chuck holding the wafer may then be rotated at a predetermined number of revolutions per minute to evenly spread the mixture from the center of the wafer to the edge of the wafer. The rotational speed of the wafer may be adjusted or the viscosity of the coating mixture may be altered to vary the resulting resin film thickness. Rotational speeds of 2500 rpm or more may be used. The amount of photoresist material applied to device surface 20 should be sufficient to provide the thick film layer 50 having the desired thickness for flow features imaged therein. Accordingly, the thickness of layer 50 after curing may range from about 10 to about 25 microns or more. Other methods that may be used to apply the thick film layer 50 to the substrate 12 include lamination processes, spray coating, blade coating, roll coating, and the like.

A photoresist formulation that may provide the thick film layer 50 may include a difunctional epoxy component, a photoacid generator, a non-reactive solvent, and, optionally, an adhesion enhancing agent. Another photoresist formulation that may be used may include a multi-functional epoxy compound, a difunctional epoxy compound, a photoacid generator, a non-reactive solvent, and, optionally, an adhesion enhancing agent.

In the foregoing photoresist formulations, the difunctional epoxy component may be selected from difunctional epoxy compounds which include diglycidyl ethers of bisphenol-A (e.g. those available under the trade designations “EPOON 1007F”, “P7N1007” and “EPON 1009F”, available from Shell Chemical Company of Houston, Tex. , “DDER-331”, “DER-332”, and “DER-334”, available from Dow Chemical Company of Midland, Mich., 3,4-epoxycyclohexylmethyl-3,4-epoxycyclo-hexene carboxylate (e.g “ERL-4221” available from Union Carbide Corporation of Danbury, Connecticut, 3,4-epoxy-6-methylcyclohexyl methyl-3,4-epoxy-6-methylcyl-clohexene carboxylate (e.g. “ERL-4201” available from Union Carbide Corporation), bis(3,4-epoxy-6-methylcyclohexylmethyl) adipate (e.g. “ERL-4289” available from Union Carbide Corporation) and bis(2,3-epoxycyclopentyl)ether (e.g. “ERL-0400” available from Union Carbide Corporation).

A particularly suitable difunctional epoxy component is a bisphenol-A/epichlorohydrin epoxy resin available from Shell Chemical Company of Houston, Tex. under the trade name EPON resin 1007F having an epoxide equivalent of greater than about 1000 An “epoxide equivalent” is the number of grams of resin containing I gram-equivalent of epoxide. The weight average molecular weight of the difunctional epoxy component is typically above 2500, e.g., from about 2800 to about 3500 weight average molecular weight in Daltons. The amount of difunctional epoxy component in the photoresist formulation may range from about 30 to about 95 percent by weight based on the weight of the cured resin.

A photoacid generator may also be included in the photoresist formulation. The photoacid generator may be selected from a compound or mixture of compounds capable of generating a cation such as an aromatic complex salt which may be selected from onium salts of a Group VA element, onium salts of a Group VIA element, and aromatic halonium salts. Aromatic complex salts, upon being exposed to ultraviolet radiation or electron beam irradiation, are capable of generating acid moieties which initiate reactions with epoxides. The photoacid generator may be present in the photoresist formulation in an amount ranging from about 0.5 to about 15 weight percent based on the weight of the cured resin.

Examples of aryl-substituted onium complex salt photoinitiators which may be used in the formulations according to the first embodiment include, but are not limited to:

triphenylsulfonium tetrafluoroborate,

triphenylsulfonium hexafluorophosphate,

triphenylsulfonium hexafluoroantimonate,

tritolysulfonium hexafluorophosphate,

anisyldiphenylsulfonium hexafluoroantimonate,

4-butoxyphenyidiphenylsulfonium tetrafluoroborate,

4-chlorophenyidiphenylsulfonium hexafluoroantimonate,

4-acetoxy-phenyldiphenylsulfonium tetrafluoroborate,

4-acetamidophlenyldiphenylsulfonium tetrafluoroborate,

diphenyliodonium trifluoromethanesuIfonate,

(p-tert-butoxyphenyl)phenyliodonium trifluoromethanesulfonate,

diphenyliodonium p-toluenesulfonate,

(p-tert-butoxyphenyl)-phenyliodonium p-toluenesulfonate,

bis(4-tert-butylphenyl)iodonium hexafluorophosphate, and

diphenyliodonium hexafluoroantimonate.

Of the triaryl-substituted sulfonium complex salts which are suitable for use in the formulations of the first embodiment, a particularly useful salt may be a mixture of triarylsulfonium hexafluoroantimonate salt, commercially available from Union Carbide Corporation under the trade name CYRACURE UVI-6974. A particularly suitable iodonium salt for use as a photoacid generator for the photoresist formulations described herein may be a mixture of diaryliodonium hexafluoroantimonate salts, commercially available from Sartomer Company, Inc. of Exton, Pa. under the trade name SARCAT CD 1012.

As set forth above, another photoresist formulation that may be used contains the multifunctional epoxy component. A suitable multifunctional epoxy component for making the photoresist formulation may be selected from aromatic epoxides such as glycidyl ethers of polyphenols. A particularly useful multifunctional epoxy resin may be a polyglycidyl ether of a phenolformaldehyde novolac resin, such as a novolac epoxy resin having an epoxide gram equivalent weight ranging from about 190 to about 250 and a viscosity at 130° C. ranging from about 10 to about 60 poise, which is available from Resolution Performance Products of Houston, Tex. under the trade name EPON RESIN SU-8.

When present in a photoresist formulation, the multi-functional epoxy component may have a weight average molecular weight of from about 3,000 to about 5,000 as determined by gel permeation chromatography, and an average epoxide group functionality of greater than 3, such as from about 6 to about 10. The amount of multifunctional epoxy resin in the photoresist formulation may range from about 30 to about 50 percent by weight based on the weight of the cured thick film layer 50

The photoresist formulations described herein may optionally include an effective amount of an adhesion enhancing agent such as a silane compound. Silane compounds that are compatible with the components of the photoresist formulation typically have a functional group capable of reacting with at least one member selected from the group consisting of the multifunctional epoxy compound, the difunctional epoxy compound and the photoinitiator. Such an adhesion enhancing agent may be a silane with an epoxide functional group such as a glycidoxyalkyltrialkoxysilane, e.g., gamma-glycidoxypropyltrimethoxysilane. When used, the adhesion enhancing agent may be present in an amount ranging from about 0.5 to about 5 weight percent, such as from about 0.9 to about 4.5 weight percent based on total weight of the cured resin, including all ranges subsumed therein. Adhesion enhancing agents, as used herein, are defined to mean organic materials soluble in the photoresist composition which assist the film forming and adhesion characteristics of the thick film layer 50.

In order to provide the thick film layer 50 on, for example, the device surface 20 of the substrate 12 (FIG. 7), a suitable solvent may be used. A suitable solvent might include a solvent which is generally non-photoreactive. Non-photoreactive solvents include, but are not limited gamma-butyrolactone, C₁₋₆ acetates, tetrahydrofuran, low molecular weight ketones, mixtures thereof and the like. A particularly suitable non-photoreactive solvent may be acetophenone. The non-photoreactive solvent may be present in the formulation mixtures used to provide the thick film layer 50 in an amount ranging of from about 20 to about 90 weight percent, such as from about 40 to about 60 weight percent, based on the total weight of the photoresist formulation. The non-photoreactive solvent typically does not remain in the cured thick film layer 50, and may be removed prior to or during the thick film layer 50 curing steps.

Once the thick film layer 50 is spin coated onto the substrate wafer, the resulting substrate wafer having the thick film layer 50 is then removed from the chuck, manually or mechanically, and placed on a temperature controlled hotplate or in a temperature controlled oven at a temperature of about 90° C. for about 30 seconds to about 1 minute until the material is “soft” baked. This step can be used to remove at least a portion of the solvent from the thick film layer 50, resulting in a partially dried film. The wafer may be removed from the heat source and allowed to cool to room temperature.

According to an exemplary embodiments prior to imaging and developing the thick film layer 50, the fluid feed slot 28 is formed in the substrate, such as by an etching process. An exemplary etching process is a dry etch process such as deep reactive ion etching or inductively coupled plasma etching. During the etching process, the thick film layer 50 may act as an etch stop layer.

In order to define flow features in the thick film layer 50, such as a fluid chamber 52 and fluid flow channel 54 (FIG. 9), the layer 50 may be masked with a mask 56 (FIG. 8) containing substantially transparent areas 58 and substantially opaque areas 60 thereon. Areas of the thick film layer 50 masked by the opaque areas 60 of the mask 56 can be removed upon developing to provide the flow features described above.

In FIG. 8, a radiation source provides actinic radiation indicated by arrows 62 to image the thick film layer 50. A suitable source of radiation emits actinic radiation at a wavelength within the ultraviolet and visible spectral regions. Exposure of the thick film layer 50 may be from less than about 1 second to 10 minutes, such as about 5 seconds to about one minute, depending upon the amounts of particular epoxy materials and aromatic complex salts being used in the formulation and depending upon the radiation source, distance from the radiation source, and the thickness of the thick film layer 50. The thick film layer 50 may optionally be exposed to, for example, electron beam irradiation instead of ultraviolet radiation.

The foregoing procedure is similar to a standard semiconductor lithographic process. The mask 56 may be a clear, flat substrate (usually glass or quartz) with opaque areas 60 defining the areas to be removed from the layer 50 (ie. a negative acting photoresist layer 50). The opaque areas 60 prevent the ultraviolet light from cross-linking the layer 50 masked beneath it. The exposed areas of the layer 50 provided by the substantially transparent areas 58 of the mask 56 are subsequently baked at a temperature of about 90° C. for about 30 seconds to about 10 minutes, such as from about 1 to about 5 minutes, to complete the curing of the thick film layer 50.

The non-imaged areas of the thick film layer 50 are then solubilized by a developer and the solubilized material is removed, leaving the imaged and developed thick film layer 50, as shown in FIG. 9. The developer may come into contact with the substrate 12 and thick film layer 50 through, for example, immersion and agitation in a tank-like setup or by spraying the developer on the substrate 12 and thick film layer 50. Either spray or immersion should adequately remove the non-imaged material. Illustrative developers include, for example, butyl cellosolve acetate, a xylene and butyl cellosolve acetate mixture, and C₁₋₆ acetates like butyl acetate. After developing the layer 50, substrate 12 having the layer 50 is optionally baked at temperature ranging from about 150° C. to about 200° C., such as from about from about 170° C. to about 190° C., for about 1minute to about 60 minutes, such as from about 15 to about 30 minutes.

With reference now to FIG. 10, subsequent to imaging and developing the thick film layer 50, a nozzle plate 64 may be laminated to the thick film layer 50 The nozzle plate 64 may be substantially rectangular and will be etched in a subsequent step to provide nozzles therein which, in an exemplary embodiment, are in axial alignment with the ejection actuators 14 and fluid chambers 22. In other embodiments, there may be desired offsets effectuated between the nozzles, ejection actuators, and/or fluid chambers In the case of a polyimide nozzle plate 64, the nozzle plate 64 may be adhesively attached adjacent (e.g., to) the thick film layer 50. In the case of a photoresist nozzle plate 64, for example, the nozzle plate 64 may be laminated to the thick film layer 50 using pressure and heat. The nozzle plate 64 may have a thickness typically ranging from about 10 to about 60 microns or more.

An exemplary process for etching the nozzle plate 64 according to the disclosure is illustrated in FIGS. 1-18. As a first step in the process, a photoresist layer 66 is spin coated or laminated to the nozzle plate 64. The photoresist layer 66 may be selected from commercially available positive acting photoresist materials, negative acting photoresist materials, and electron-beam photoresist materials, or may be provided by the photoresist materials described above. For the purposes of illustration in FIGS. 11-18, a positive photoresist material is used to provide the photoresist layer 66. The photoresist layer 66 has a thickness that is about the same as the thickness of the nozzle plate 64.

As in the process used to define the flow features (22 and 24) in the thick film layer 50, a mask 68 containing transparent areas 70 and opaque areas 73 may be used to define the location for nozzles in the nozzle plate 64. The procedures for imaging the photoresist layer 66 are similar to the procedures described above with respect to imaging the thick film layer 50 and thus will not be repeated.

However, after imaging the photoresist layer 66, developing of the imaged photoresist layer 66 is omitted. Instead, a step of silylating the photoresist layer is conducted, as illustrated in FIG. 13. According to such a process, the substrate 12 having the thick film layer 50, nozzle plate 64 and imaged photoresist layer 66 is placed in an etching chamber in the presence of a gaseous silicon containing material 71. Suitable silicon containing materials may be selected from hexamethyldisilazane (HMDS), trimethylchlorosilane, dimethyldichlorosilane, methyltrichlorosilaane, trimethylbromosilanie, trimethyliodosilane, triphenylchlorosilane, heptamethyldi-silazane, and hexaphenyldisilazane. The silylation step may be conducted at a temperature ranging from about 150° to about 180° C., and at a pressure ranging from about 760 to about 200 Torr, for a period of time sufficient to silylate a portion 72 of the photoresist layer 66, as shown in FIG. 14. The thickness of the silylated portion 72 may range from about 1% to about 50% of the total thickness of the photoresist layer 66, and typically may range from about 10 to about 25% of the total thickness of the photoresist layer 66.

Silylation of the portion of the photoresist layer 66 provides a silicon containing film-resist matrix specific only to exposed areas 74 and 76 of the photoresist layer 66 as provided by mask 68 (FIG. 12). For a positive photoresist layer 66, the exposed areas 74 and 76 are deprotected areas that are rendered soluble in a developing solution as a result of exposure to actinic radiation. A masked area 78 remains insoluble in a developing solution and also is incapable of forming a silicon containing film-resist matrix. Accordingly, the masked area 78 may be etched in the presence of suitable etching plasma conditions.

Since the substrate 12 having the thick film layer 50, nozzle plate 66, and photoresist layer 66 is already in the etching chamber, organic etchants 80 containing oxidizing chemistries may next be introduced into the etching chamber as shown in FIG. 15. Under these conditions, the deprotected exposed areas 74 and 76 containing the silicon containing film-resist matrix react to form etch impenetrable layers of silicon dioxide in the exposed areas 74 and 76. Tie masked area 78 concurrently begins to etch and continues to etch, exposing the underlying polyimide nozzle plate 66 in area 78 as shown in FIG. 16. Only the exposed areas of the polyimide nozzle plate 66 etch as shown to form a nozzle 82 under the etching conditions used.

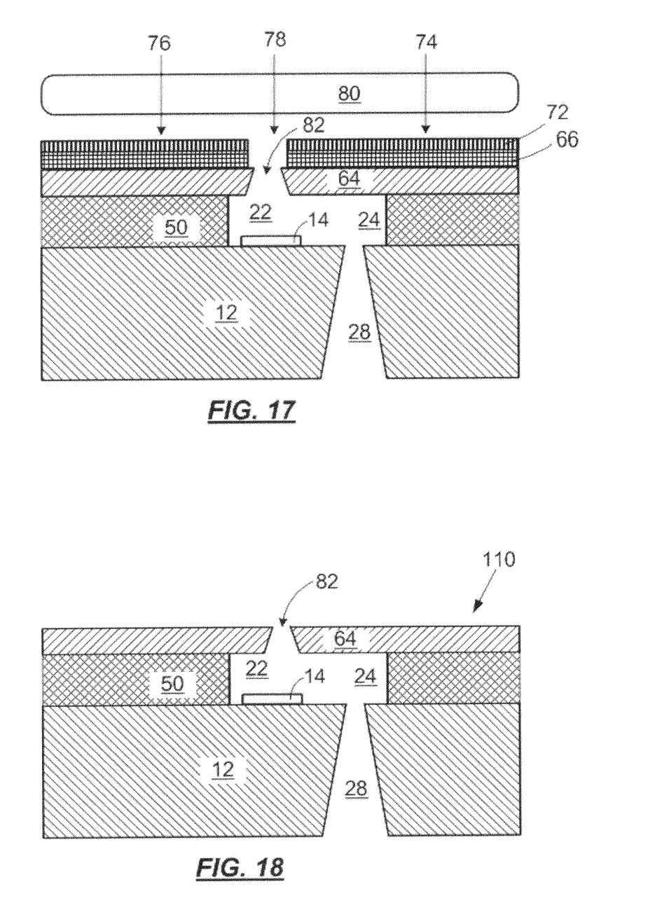

Once the nozzle 82 is formed, the substrate 12 having the thick film layer 66, newly etched nozzle plate 64 and photoresist layer 66 may be exposed to a developing solvent which is effective to remove the photoresist layer 66 containing the silylated portion 72 from the nozzle plate 64. A resulting micro-fluid ejection head 84 is illustrated in FIG. 18. It will be appreciated from the foregoing description that silylation and etching of the nozzle plate 64 may be conducted sequentially in the etching chamber. Accordingly, multiple movements of the structures to different processing stations are avoided. Since the nozzles 82 and flow features 22 and 24 are formed in layers attached to the substrate 12, alignment problems associated with multi-part processing steps may also be minimized.

In an exemplary alternative process, a negative photoresist material may be used in place of positive photoresist material 66. In that case, the mask 68 has opaque areas 70 and transparent area 73. Only the masked areas 74 and 76 of the negative photoresist material are silylated while area 78 remains unsilylated as before. Formation of nozzles 82 may then proceed as in FIGS. 15-18 as set forth above.

In yet another alternative process a reverse acting positive photoresist material may be used. In this process the same mask as describe above with respect to the negative photoresist material may be used to provide masked areas 74 and 76 and unmasked area 78. After baking to cross-link the unmasked area 78, the photoresist material is silylated to provide areas 74 and 76 that are silylated and area 78 that remains unsilylated. Formation of the nozzles using the reverse acting positive photoresist material may then proceed as described above.

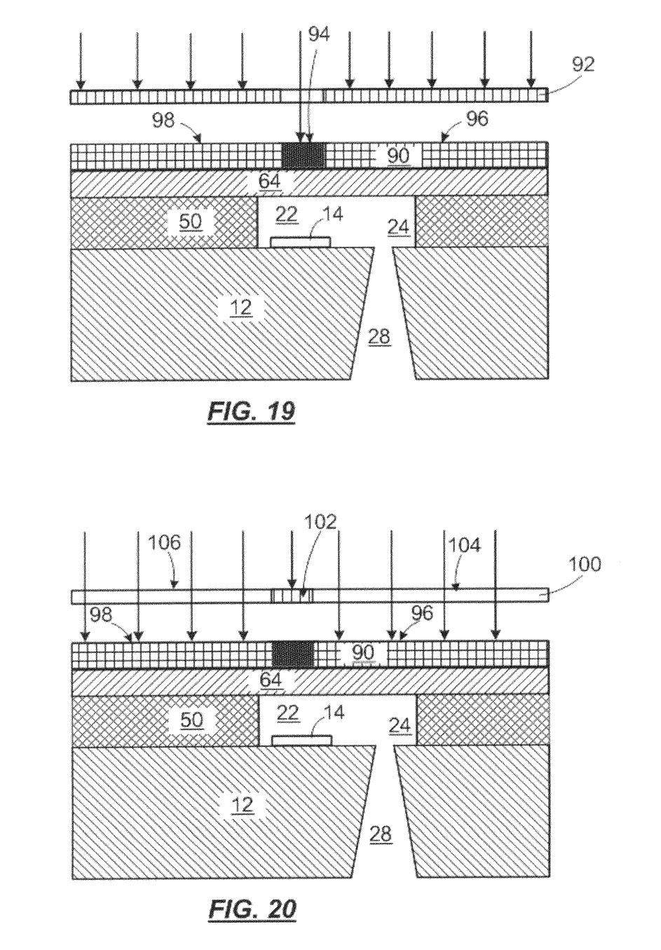

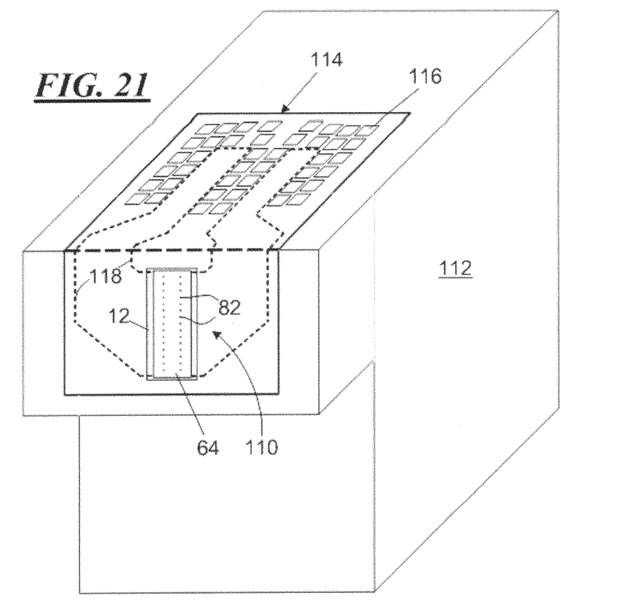

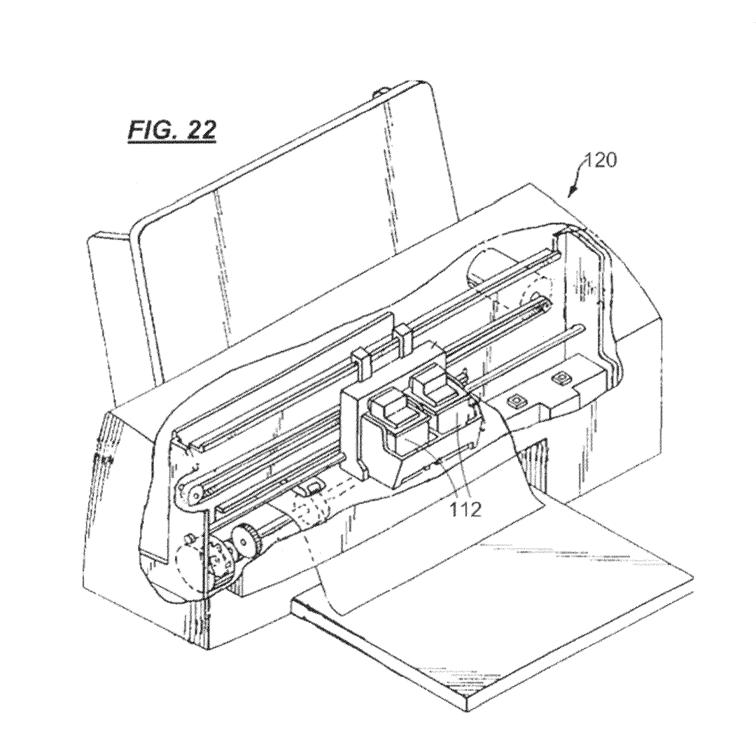

Another alternative process that may be used includes the use of an electron-beam photoresist material 90. A portion of a process for using an electron-beam photoresist material is illustrated in FIGS. 19-20. According to this process a first mask 92 is used to expose an area 94 of the electron-beam photoresist material 90 with a relatively short wave length electron beam having a wave length of less than about 400 nanometers as shown in FIG. 19 while areas 96 and 98 remain unexposed to the electron-beam radiation. Next, a second mask 100 is used having opaque area 102 and transparent areas 104 and 106 for exposure of areas 96 and 98 to a relatively long wave length electron-beam having a wave length of greater than about 400 nanometers. In this process areas 96 and 98 are made more prone to diffusion in a subsequent silylation step as describe above. Accordingly, formation of nozzles 82 using the electron-beam photoresist material 90 may then proceed as described above with reference to FIGS. 13-18.

After fabricating the micro-fluid ejection head structure 110, the micro-fluid ejection head 110 may be attached to a fluid supply reservoir 112 as illustrated in FIG. 19. The fluid reservoir 112 includes a flexible circuit 114 containing electrical contacts 116 thereon for providing control and actuation of the fluid ejector actuators 14 on the substrate 12 via conductive traces 118. One or more reservoirs 112 containing the ejection heads 110 may be used in a micro-fluid ejection device 120, such as an ink jet printer as shown in FIG. 20 to provide control and ejection of fluid from the ejection heads 110.

It is contemplated and will be apparent to those skilled in the art from the preceding description and the accompanying drawings that modifications and/or changes may be made in the embodiments of the disclosure Accordingly, it is expressly intended that the foregoing description and the accompanying drawings are illustrative of exemplary embodiments only, not limiting thereto and that the true spirit and scope of the present disclosure be determined by reference to the appended claims.

What is claimed is:

1. A micro-fluid ejection head structure comprising:
a substrate having a plurality of fluid ejection actuators;
a thick film layer adjacent the substrate, the thick film layer having a fluid chamber and a fluid flow channel capable of providing fluid to the fluid chamber; and
a polymeric nozzle plate adjacent the thick film layer, the polymeric nozzle plate having a nozzle therein capable of being in fluid communication with one or more of the fluid flow chambers, wherein the nozzle comprises a plasma etched nozzle defined by a photoresist mask layer.

2. The micro-fluid ejection head structure of claim 1, wherein the polymeric nozzle plate comprises a polyimide nozzle plate.

3. The micro-fluid ejection head structure of claim 1, wherein the photoresist mask layer comprises a silylated positive photoresist mask layer.

4. The micro-fluid ejection head structure of claim 1, wherein the photoresist mask layer comprises a silylated negative photoresist mask layer.

5. The micro-fluid ejection head structure of claim 1, wherein the photoresist mask layer comprises a silylated electron-beam photoresist mask layer.

6. The micro-fluid ejection head structure of claim 17 wherein the thick film layer comprises a photoimaged thick film layer.

7. The micro-fluid ejection head structure of claim 1, wherein the thick film layer comprises a laser ablated thick film layer.

8. The micro-fluid ejection head structure of claim 1, wherein the polymeric nozzle plate comprises a polymeric nozzle plate adhesively attached to the thick film layer.

9. The micro-fluid ejection head structure of claim 1, wherein the polymeric nozzle plate comprises an adhesively attached polymeric nozzle plate.

10. A method for etching a polymeric layer adjacent a thick film layer that is adjacent a substrate to provide a polymeric nozzle plate, the method comprising:
attaching a photoimageable masking layer adjacent the polymeric layer,
exposing a selected first portion of the masking layer to actinic radiation and masking a selected second portion of the masking layer so that the second portion is not exposed to actinic radiation;
treating the photoimageable masking layer with a silylation agent under conditions sufficient to provide an etch resistant masking layer in the selected first portions of the masking layer; and
patterning and etching the photoimageable masking layer, and etching the polymeric layer using a reactive ion etching plasma to provide a plurality of nozzles in the polymeric layer.

11. The method of claim 10, wherein the polymeric layer comprises a polyimide material and the polymeric layer comprises a polyimide material

12. The method of claim 10, wherein the act of treating the photoimageable masking layer comprises treating the photoimageable masking layer with a compound selected from the group consisting of hexamethyldisilazane (HMDS), trimethyl-chlorosilane, dimethyldichlorosi lane, methyltrichlorosilane, trimethylbromosi lane, trimethyliodosilane, triphenylchlorosilane, heptamethyldisilazane, and hexaphenyldisilazane.

13. The method of claim 10 wherein the act of treating with the silylation agent is conducted in an oxygen plasma.

14. The method of claim 10, wherein the act of treating with the silylation agent is conducted at a temperature ranging from about 150 to about 180° C.

15. The method of claim 10, wherein the act of treating with the silylation agent is conducted at a pressure ranging from about 760 to about 200 Torr.

16. The method of claim 10, further comprising removing the selected first portions of the masking layer from the etched polymeric layer using conventional photoresist developing solvents.

17. A method for making a micro-fluid ejection head structure, comprising:
applying a polyimide layer adjacent a thick film layer that is adjacent a substrate, the substrate having a plurality of fluid ejection actuators associated therewith and the thick film layer defining a fluid flow channel and a fluid chamber in flow communication with the fluid flow channel;
attaching a photoimageable masking layer adjacent the polyimide layer;
exposing a selected first portion of the masking layer to actinic radiation and masking selected second portions of the masking layer so that the second portions are not exposed to actinic radiation;
treating the photoimageable masking layer with a silylation agent under conditions sufficient to provide an etch resistant masking layer in the selected second portions of the masking layer;
patterning and etching the photoimageable masking layer, and etching the polyimide layer using an oxygen reactive ion etching plasma to provide a plurality of nozzles in the polyimide layer; and
removing the photoimageable masking layer from the etched polyimide layer,

18. The method of claim 17, wherein the photoimageable masking layer comprises a negative photoresist layer.

19. The method of claim 17, wherein the photoimageable masking layer comprises a reverse acting positive photoresist layer.

20. The method claim 17, wherein the silylation agent comprises a compound selected from the group consisting of hexamethyldisilazane (HMDS), trimethyl-chlorosi lane, dimethyldichlorosilane, methyltrichlorosilane, trimethylbromosilane, trimethyliodosilane, triphenylchlorosilane, heptamethyldisilazane, and hexaphenyldisilazane.
